(19) United States
(12) Patent Application Publication
(10) Pub. No.: US 2002/0190934 A1
(43) Pub. Date: Dec. 19, 2002

(54) Drive unit for a luminescence display panel

(75) Inventors: Takayoshi Yoshida, Yonezawa-shi (JP); Shinobu Adachi, Yonezawa-shi (JP)

Correspondence Address: ARMSTRONG,WESTERMAN & HATTORI, LLP, 1725 K STREET, NW., SUITE 1000, WASHINGTON, DC, 20006, US

(73) Assignee: Tohoku Pioneer Corporation, Tendo-shi (JP)

(21) Appl. No.: 10/151,181

(22) Filed: May 21, 2002

(30) Foreign Application Priority Data
Jun. 5, 2001 (JP) 2001-169895

(51) Int. Cl. G09G 3/30

(52) U.S. Cl. 345/76

(57) ABSTRACT

In a luminescence display panel employing organic EL elements, at the time of switching of a normal scan mode and a partial scan mode, occurrence of an unpleasant phenomenon such as flicker and the like on a display screen is restrained. When a switching command for changing a scan mode is supplied from a scan mode alteration circuit (13) to a light emission control section (11), a control circuit (18) controls so that a switching operation of a scan mode is executed at the time of scanning start of a first scan line or during scanning of a dummy line set after a final scan line. Thus, in a luminescence display panel (1) employing organic EL elements, a light emission display by a new scan mode is performed from the first scan line in one frame, and occurrence of an unpleasant phenomenon such as flicker can be restrained.

### BACKGROUND OF THE INVENTION

1. Field of the Invention

The present invention relates to a drive unit for a luminescence display panel employing, for example, organic EL (electroluminescence) elements, and particularly to a drive unit for a luminescence display panel which can restrain an unpleasant phenomenon such as flicker and the like on a display screen which occurs at the time of switching between a normal scan mode in which all effective light-emitting elements in a luminescence display panel are repeatedly scanned to control the luminescence and a partial scan mode in which part of the effective light-emitting elements in the luminescence display panel are repeatedly scanned to control the luminescence.

2. Description of the Related Art

An organic EL display has drawn attention as a display in which a low power consumption, a high display quality, and a thin profile are possible in place of a liquid crystal display. This is because there is a background that a high efficiency and a long life by which a practical use can be endured are progressed by employing an organic compound by which an excellent light emission characteristic can be expected for a light emitting layer of EL elements employed for an EL display.

The organic EL element can be electrically expressed by an equivalent circuit as shown in FIG. 7. That is, an organic EL element can be replaced by a structure composed of a parasitic capacitance compound C and a diode compound E which is connected in parallel to the capacitance compound, and the organic EL element is deemed as a capacitive light-emitting element. In the organic EL element, when a light emission drive voltage is applied, first, electrical charge corresponding to the capacitance of the element flows into an electrode as a displacement current and is stored therein. Then, when the electrical charge exceeds a predetermined voltage (light emission threshold value=Vth) inherent in the element, current begins to flow from the electrode (anode side of the diode element E) to an organic layer constituting the light emitting layer, and it can be deemed that light is emitted at an intensity proportional to the current.

FIG. 8 shows static light emission characteristics of such organic EL element. It can be seen from the drawing that in the organic EL element, in the case where the drive voltage (V) is at a light emission threshold voltage (Vth) or greater as shown in FIG. 8A, current (I) suddenly flows to cause light emission. In other words, if the drive voltage applied is at the light emission threshold voltage or lower, after charging for the parasitic capacitance, drive current hardly flows in the EL element, and thus the element does not emit light. In a light emittable region in which the drive voltage (V) is the light emission threshold voltage or greater, the EL element has a characteristic that the EL element emits light with a luminance (L) approximately proportional to the drive current (I) as shown in FIG. 8B. Thus, an EL element has a luminance characteristic in which the greater the voltage (V) applied thereto, the greater the luminance (L) thereof in the light emittable region in which the drive voltage (V) is greater than the threshold voltage as shown in FIG. 8C.

As a driving method for a display panel constituted by arranging such plurality of organic EL elements, a passive matrix driving method can be applied. FIG. 9 shows an example of a passive matrix display panel and a drive unit therefor. In the passive matrix driving method, there are two driving methods for the organic EL elements, cathode line scan/anode line drive and anode line scan/cathode line drive, and FIG. 9 shows a feature of the former, the cathode line scan/anode line drive. That is, “n” pieces of anode lines A1 to An are arranged as drive lines in a vertical direction, “m” pieces of cathode lines B1 to Bm are arranged as scan lines in a horizontal direction, and organic EL elements E11 to Enm are arranged at portions at which each line intersects (“n”×“m” portions in total) to construct a display panel 1.

The respective elements E11 to Enm constituting pixels are arranged in the form of a lattice, and one ends (anode terminals of the diode elements EL of the equivalent circuit described above) are connected to the anode lines and the other ends (cathode terminals of the diode elements EL of the equivalent circuit described above) are connected to the cathode lines, corresponding to intersecting positions between the anode lines A1 to An along the vertical direction and the cathode lines B1 to Bm along the horizontal direction. The anode lines are connected to an anode line drive circuit 2, and the cathode lines are connected to a cathode line scan circuit 3 so that the respective lines are driven thereby.

The cathode line scan circuit 3 is provided with scan switches SY1 to SYm corresponding to the respective cathode scan lines B1 to Bm to work so that either one of a reverse bias voltage VM from a power supply circuit 5 (for example, 10 V) and the ground potential (0 V) is connected to a corresponding cathode scan line. The anode line drive circuit 2 is provided with drive sources I1 to In supplying drive current to the respective EL elements via the respective anode lines and drive switches SX1 to SXn, and the drive switches are controlled to be turned on so that current from the drive sources I1 to In is supplied to the respective EL elements arranged corresponding to the cathode scan lines.

Thus, the drive sources are connected to desired anode drive lines while the cathode scan lines are scanned at a predetermined cycle so that the respective light emitting elements are selectively caused to emit light. Although voltage sources such as constant voltage circuits can be employed as the drive sources, it is general to employ constant current sources as the drive sources because of the reasons that the voltage/luminance characteristic of an EL element is unstable with respect to temperature changes, the element is deteriorated by excess current, and the like although the current/luminance characteristic of an EL element is stable with respect to temperature changes.

The respective anode drive lines are further connected to a reset circuit 4. This reset circuit 4 is provided with reset switches SR1 to SRn provided for the respective anode drive lines, and these reset switches are turned on, so that the anode drive lines are set to the ground potential. Each of the anode line drive circuit 2, the cathode line scan circuit 3, and the reset circuit 4 is driven by a command signal brought from a light emission control section which is not shown.

That is, the light emission control section controls the anode line drive circuit 2, the cathode line scan circuit 3, and the reset circuit 4 so that an image corresponding to an image signal is shown according to the image signal. In this case, control is performed wherein the cathode line scan circuit 3 selects one of the cathode scan lines corresponding to a horizontal scan period of image data by a command from the light emission control section to set it to the ground potential, and the scan switches SY1 to SYm are switched so that other cathode scan lines are connected to the power supply circuit 5 and the reverse bias voltage VM is applied thereto. The state shown in FIG. 9 shows a state in which the first cathode scan line B1 is scanned.

The reverse bias voltage VM is applied in order to charge the parasitic capacitance of driven EL elements which are connected to the intersections with the cathode line that has been selected for scanning and in order to prevent the EL elements connected to intersections between the driven anode lines and the cathode lines that have not been selected for scanning from emitting cross-talk light. This reverse bias voltage is generally set to a voltage approximately equal to the forward direction voltage (VF) of the EL element that is driven to emit light. Since the scan switches SY1 to SYm are switched to the ground potential one after another for each horizontal scan period, the cathode scan line set to the ground potential functions as the scan line capable of making the EL elements connected to the cathode scan line emit light.

Based on image data brought from the light emission control section, a drive control signal (drive pulse) for controlling as to which timing and how long one of the EL elements connected to the anode drive line emits light is supplied to the anode line drive circuit 2. According to this drive control signal, the anode line drive circuit 2 controls so that some of the drive switches SX1 to SXn are turned on and works so as to supply drive current to the EL elements that correspond to image information through the anode drive lines A1 to An.

Thus, the EL elements to which the drive current is supplied are driven to emit light according to the image information. The state shown in FIG. 9 is a state in which a first cathode scan line B1 is scanned as described above, and since the drive switches SX1 and SX3 are in an ON state, the EL elements E11 and E31 are driven to emit light.

A reset operation of the reset circuit 4 is performed according to a reset control signal from the light emission control section. This operation is disclosed in, for example, Japanese Patent Application Laid-Open No. Hei 9-232074 and is performed in order to speed up the light emission start of the EL element driven to emit light corresponding to the next scan line when the scan line is switched. The organic EL element has a parasitic capacitance, and, for example, in the case where several tens of EL elements are connected to one anode drive line, a total capacitance of several tens times each parasitic capacitance is deemed to be connected with the anode drive line as a load capacitance.

Accordingly, at the head of the scan period, current from the anode drive line is consumed for charging the load capacitance, and a time delay occurs for charging until charge fully exceeds the light emission threshold voltage of an EL element, whereby a problem that light emission start of the EL element is delayed occurs after all. Specifically, in the case where the constant current sources I1 to In are employed as the drive sources as described above, since the constant current sources are high impedance output circuits on an operational principle, current is limited, and a delay of light emission start of an EL element occurs markedly. Thus, a discharging operation of electrical charge by the reset circuit 4 and an applying operation of the reverse bias voltage VM by the cathode scan circuit 2 function to give a voltage that instantly exceeds the light emission threshold voltage fully to the anode terminal of an EL element which is driven to emit light in the next scan.

FIG. 10 shows a cathode reset operation by the reset circuit 4, and shows, for example, from the state in which the EL element E11 connected to the first anode drive line A1 is driven to emit light to the state in which the EL element E12 connected to the same first anode drive line A1 is driven to emit light in the next scan. In FIG. 10, the EL element which is driven to emit light is expressed as the symbol of a diode, and other is expressed by the symbol of a capacitor as a parasitic capacitance.

FIG. 10A shows a state before the cathode reset operation and shows the state in which the cathode scan line B1 is scanned, so that the EL element E11 is emitting light. Although the EL element E12 emits light in the next scan, before the EL element R12 emits light, the anode drive line A1 and all cathode scan lines are reset to the ground potential as shown in FIG. 10B, so that all electric charge is discharged. Thus, the respective scan switches SY1 to SYm are connected to the ground side, and the reset switch SR1 is turned on. Then, in order to permit the EL element E12 to emit light, the cathode scan line B2 is scanned. That is, the cathode scan line B2 is connected to the ground, and the reverse bias voltage VM is applied to other cathode scan lines. At this time, the drive switch SX1 is turned on, and the reset switch SR1 is turned off.

Consequently, since electric charge of the parasitic capacitance in each element is discharged at the time of the reset described above, at that moment, as shown in FIG. 10C, charging in the reverse direction is performed by the reverse bias voltage VM as shown by arrows for the parasitic capacitance of elements other than the element E12 that emits light in the next. Charging current for these elements flows into the EL element E12 that emits light in the next via the anode drive line A1 to charge the parasitic capacitance of the EL element E12. At this time, the constant current source I1 connected to the drive line A1 is basically a high impedance output circuit as described above and thus does not influence the movement of the charging current.

In this case, on the assumption that, for example, 64 pieces of EL elements are arranged at the drive line A1 and that the reverse bias voltage VM is 10 (V), by the charging operation described above, the electrical potential V (A1) of the anode drive line A1 momentarily increases to an electrical potential based on Equation 1 shown below since the wiring impedance inside the panel is so small that it can be ignored. This operation is completed approximately in 1 μsec in a display panel having an outer shape of, for example, about 100 mm by 25 mm (256 times 64 dots).

Equation 1

V(A1)=(VM×63+0V×1)/64=9.84V

Thereafter, the EL element E12 comes to be in a light emission state as shown in FIG. 10D by the drive current from the constant current source I1 flowing in the drive line A1. At this time of scanning, if the light emission of the EL element E12 should not be driven, the reset switch SR 1 is turned on so that the anode drive line A1 is connected to the ground. Thus, since all charging current from other elements flows into the ground, a voltage is not generated in the anode drive line A1.

As described above, in the cathode reset method, utilizing the parasitic capacitance of the EL element which is originally an obstacle for driving and the reverse bias voltage for preventing the cross-talk light emission, the forward direction voltage of the EL element which is driven to emit light in the next is instantly risen.

In the case where the cathode reset method is utilized, although the light emission start of an EL element can be performed quickly by the operation described above, an operation for resetting the electrical charge stored in the parasitic capacitance of each EL element has to be done for each cathode scan as shown in FIG. 10B. Thus, since the electric charge stored in each parasitic capacitance of the EL element is discharged by a driver IC via the anode drive line and the cathode scan line for each switching of scan, the power loss becomes greater.

In other words, the discharge of the electric charge in each parasitic capacitance accompanied by the cathode reset operation is discarded as heat. Thus, in a display pattern in which a non-emission state in which each EL element does not emit light is caused to be continued according to image information based on image data, a considerable heat loss is generated.

Considering the electrical power consumed by the operation of the cathode reset described above, the following is explained. That is, from the relationship between the capacitor capacitance (C) and the voltage (V) applied thereto, the electrical power energy (Pd) can be expressed as Pd=(½)×CV². Here, the parasitic capacitance of an EL element constituting one dot is about 4 pF. Where the VM is 10 (V) and the cathode line scan time is 170 μsec, in one dot of the non-emission state, the electrical power energy (W) consumed in one second can be expressed by the following Equation 2.

$$\begin{matrix}Pd = ( 1 / 2 ) \times 4 \times {10}^{- 12} \times {10}^{2} \times [ 1 / ( 170 \times {10}^{- 6} ) ] \\ = ( 2 / 170 ) \times ( {10}^{- 12} \times {10}^{2} ) / \times ( {10}^{- 6} ) \\ = ( 2 / 1.7 ) \times {10}^{- 6} \\ = 1.2 ( μ W ) ( rounded off to one decimal place )\end{matrix} \qquad Equation 2$$

Accordingly, when the display panel, for example, of vertically and horizontally 64 by 256 dots is considered, an electrical power energy of 75 μW in one anode drive line, that is, in 64 dots, and of 19.3 mW in all dots is consumed in one second. This electrical power loss is consumed by the operation of the cathode reset, and since this becomes greater in proportion to the number of the EL elements inside the light emission display panel, the greater the display area, the greater the useless power loss.

In general, in this type of display panel, in the state in which electrical equipment in which the display panel is arranged is not operating, only a display of the required minimum, for example, a display of time or the like, is performed, and other pixels are in the state of non-emission. However, since the cathode reset operation is performed from beginning to end for all the respective EL elements constituting the display panel as described above, the ratio of the power loss accompanied by the operation becomes enormously large.

For example, in the case where the display panel is adopted in an electrical device employing commercial power supply or in an electrical device for being loaded in a vehicle, the power loss is overlooked. However, in the case where the display panel is adopted in a portable device, an excessive battery consumption is caused. Consequently, in the case where the display panel is adopted, for example, in a portable telephone, waiting time of the portable telephone has to be drastically shortened.

Thus, in a non-operation state of an electrical device, for example, in the waiting state of a portable telephone, in order to perform a display of the required minimum, considered is a control in which chosen is a partial scan mode (hereafter, this is also referred to as partial scan) in which part of light emitting elements in the display panel are repeatedly scanned to control light emission. In the case where such partial scan is adopted, it is not necessary to perform the cathode scan for a part other than the part contributing to the display of the required minimum, and the degree of causing the power loss can be drastically reduced.

A method in which the partial scan is adopted, for example, in a liquid crystal display device (LCD), has been already proposed. Regarding a low power consumption by the partial scan suitably adopted in the LCD, the following two kinds of means can be proposed. The first is a method in which in accordance with the ratio of a specific part to be displayed to the whole display part, the drive voltage for the LCD can be decreased, and as a result, the power consumption can be reduced. The second is a method in which the power consumption is reduced by stopping a booster circuit and a drive circuit at the time of scanning a part other than a specific part to be displayed.

It is deemed that the effect for reducing the power consumption is greater when the former method is adopted. In the case where the former method is adopted, at the time of change over from a normal scan mode in which all effective pixels are repeatedly scanned to control the drive to the partial scan, the operations of a display drive circuit, a booster circuit, and the like are momentarily shut off, during this shut off period, a drive voltage from a booster circuit and the like corresponding to the partial scan is set again, and then the operation of the booster circuit and the like is started. Thus, in the case where a display off period is provided and during that period a duty cycle and the like corresponding to the partial scan is set, since the responsiveness of the display of the LCD to a drive signal is slow, inconvenience, such as flicker, causing unpleasant feeling in person's eyes does not occur.

In the case where the drive method for the LCD described above is adopted as it is in the drive unit for a luminescence display panel according to the present invention, it can also be expected to reduce the power consumption required for the light emission of the elements, other than the power loss due to the cathode reset. That is, by executing the partial scan, the current value of the case where a light emitting element is driven by a constant current can be decreased, and as a result, the power consumption can be reduced. Even in the case where a light emitting element is driven by a constant voltage, since its voltage value can be decreased similarly, as a result, the power consumption can be reduced.

However, in the driving of this type of luminescence display panel, for example, at the time of switching from the normal scan mode to the partial scan, if a control sequence for shutting off the operation of a display drive circuit and the like similarly to the drive method for the LCD is adopted, obviously an unpleasant display state including flicker and the like occurs. In order to avoid the occurrence of such phenomenon, if a scan mode is switched on the halfway of scanning of one frame without providing a time period for shutting off the operation of the display drive circuit and the like, the inventor applying the present invention and the like found that a phenomenon such as unpleasant flicker and the like becomes further striking, and the display quality is deteriorated.

### SUMMARY OF THE INVENTION

The present invention was developed based on a technical point of view described above, and it is an object to provide a drive unit for a luminescence display panel by which occurrence of inconvenience such as flicker and the like occurring on a display screen at the time of switching of the scan mode in a luminescence display panel which can selectively adopt the partial scan can be cancelled.

A drive unit for a luminescence display panel according to the present invention developed to solve the problem described above is a drive unit for a luminescence display panel which includes a plurality of drive lines and a plurality of scan lines intersecting each other and a plurality of capacitive light emitting elements connected between the drive lines and the scan lines at a plurality of intersecting positions by the drive lines and the scan lines, wherein the drive unit comprises a light emission control means which can select a normal scan mode in which all effective light emitting elements in the luminescence display panel are repeatedly scanned to control the luminescence thereof and a partial scan mode in which part of the effective light emitting elements in the luminescence display panel are repeatedly scanned to control the luminescence thereof, wherein the light emission control means executes a switching operation for the respective scan modes in synchronism with scanning start of a first scan line in each scan mode.

There is a case where the light emission control means is constituted to execute a switching operation for the respective scan modes during scanning of a dummy line set after a final scan line in each scan mode.

In this case, in either configuration of the former and the latter, preferably, the light emission control means is constituted to perform a switching operation from the normal scan mode to the partial scan mode and a switching operation from the partial scan mode to the normal scan mode. Also, preferably, the light emission control means is constituted to perform a switching operation from the partial scan mode to another partial scan mode.

In a preferred embodiment of the former, the light emission control means is constituted to output a switching command at the time of the scanning start of a first scan line whose light emission should be controlled in the next after receiving a switching command from a scan mode alteration means so that a scan mode can be switched in synchronism with the output of the switching command.

In another preferred embodiment of the former, the light emission control means is constituted so as to outputs a switching command in synchronism with a switching command from a scan mode alteration means and is constituted, so that a scan mode can be switched at the time of the scanning start of a first scan line whose light emission should be controlled in the next.

In a preferred embodiment of the latter, the light emission control means is constituted to output a switching command at the time of the scanning of the dummy line after receiving a switching command from a scan mode alteration means, so that a scan mode can be switched in synchronism with the switching command.

Further, in another preferred embodiment of the latter, the light emission control means is constituted to output a switching command in synchronism with a switching command from a scan mode alteration means and is constituted so that a scan mode can be switched at the time of the scanning of the dummy line.

In either configuration of the former and the latter, it is desirable that the light emission control means is provided with a scan period alteration means for changing the scan period of a first scan line in accordance with the number of scan lines in each scan mode. Further, it is desirable that the light emission control means is provided with a luminance variable means for controlling emission luminance in accordance with the number of scan lines in each scan mode.

It is desirable that the light emission control means is provided with a reset control means for setting a reset period for each end of the scan period of the first scan line, and that the reset control means is constituted to execute an operation for making the electrical potentials of all of the plurality of drive lines and the plurality of scan lines the same during the reset period. Further, the present invention can be suitably utilized in a drive unit for a luminescence display panel in which organic electroluminescence are employed for the light emitting elements.

With the drive units having the configurations described above, a normal scan mode in which all effective light emitting elements in the luminescence display panel are repeatedly scanned to control the luminescence thereof and a partial scan mode in which part of the effective light emitting elements in the luminescence display panel are repeatedly scanned to control the luminescence thereof can be selected as the need arises. In this case, a switching operation from the normal scan mode to the partial scan mode and conversely a switching operation from the partial scan mode to the normal scan mode are performed. Further, there is a case where a switching operation from the partial scan mode to another partial scan mode is performed.

As described above, where the partial scan mode is adopted as the need arises, the power loss can be reduced compared with the operation of the normal scan mode. For example, in the case of return from the partial scan mode to the normal scan mode, the switching operation to the normal scan mode is executed in synchronism with the scanning start of a first scan line in the normal scan mode. Or, the switching operation to the normal scan mode is executed during the scanning of the dummy line set after the final scan line in the partial scan mode.

By adopting the switching timing described above, it is possible to avoid a state in which part of an image in the normal scan mode and part of an image in the partial scan mode coexist and are displayed in one frame on the display screen, and occurrence of inconvenience that is obviously found as flicker in human eyesight can be solved.

### BRIEF DESCRIPTION OF THE DRAWINGS

FIG. 1 is a connection diagram showing a fundamental structure of a drive unit according to the present invention;

FIG. 2 is a block diagram showing a structural example of a light emission control section in the drive unit shown in FIG. 1;

FIG. 3 is a schematic view showing a scan operation example by the drive unit according to the present invention;

FIG. 4 is timing charts showing relationships between scan periods and reset periods of the case where scan modes are switched;

FIG. 5 is timing charts showing preferred embodiments of the case where a scan mode is switched;

FIG. 6 is timing charts showing preferred examples of the case where a scan mode is switched;

FIG. 7 is a drawing showing an equivalent circuit of an organic EL element;

FIG. 8 is characteristics views showing various characteristics of the organic EL element;

FIG. 9 is a connection diagram showing a drive unit for a conventional EL luminescence display panel; and

FIG. 10 is connection diagrams for explaining a cathode reset operation in the structure shown in FIG. 9.

### DESCRIPTION OF THE PREFERRED EMBODIMENTS

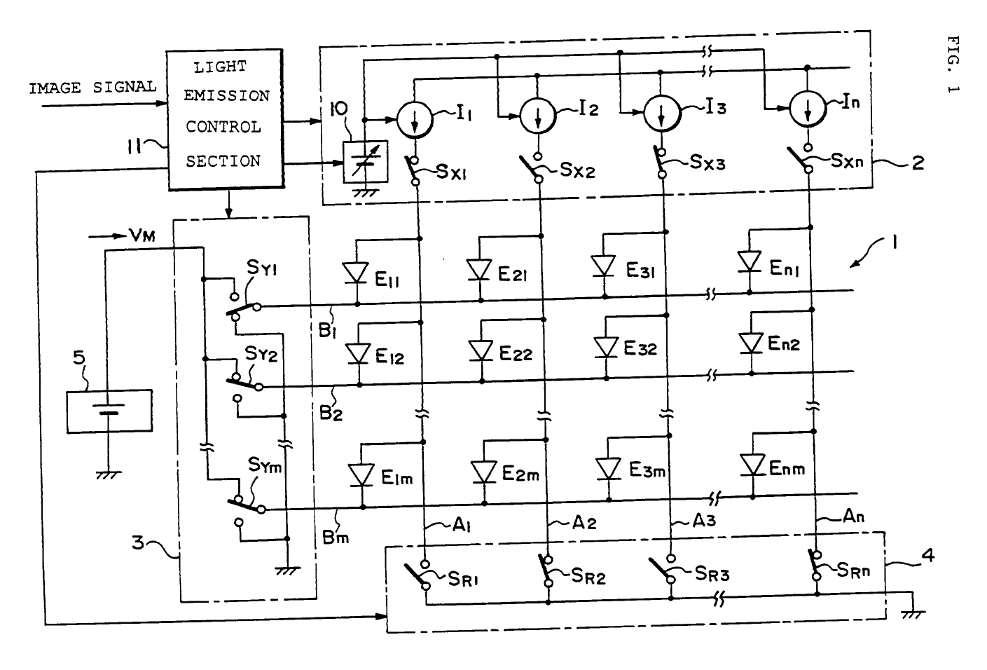

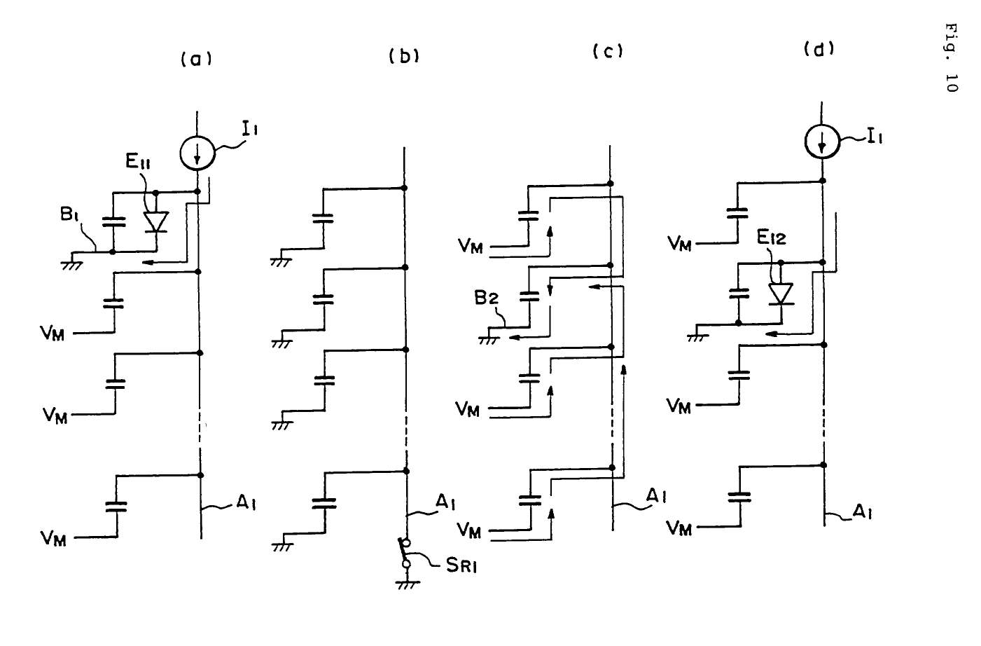

An embodiment of a drive unit for a luminescence display panel according to the present invention is explained below with reference to drawings. In this embodiment, an organic EL element is employed as a light-emitting element, and a cathode line scan/anode line drive feature similar to the one explained using FIG. 9 is adopted in the embodiment shown in FIG. 1. That is, in a display panel 1, “n” pieces of anode lines A1 to An are arranged as drive lines in a vertical direction, “m” pieces of cathode lines B1 to Bm are arranged as scan lines in a horizontal direction, and organic EL elements E11 to Enm are arranged at portions at which each line intersects (n×m portions in total)

The respective elements E11 to Enm constituting pixels are arranged in the form of a lattice, and anode terminals of the EL elements are connected to the anode lines A1 to An and the cathode terminals of the EL elements are connected to the cathode lines B1 to Bm, corresponding to intersecting positions between the anode lines A1 to An along the vertical direction and the cathode lines B1 to Bm along the horizontal direction. The respective anode lines are connected to an anode line drive circuit 2 and a reset circuit 4, and the respective cathode lines are connected to a cathode line scan circuit 3, so that the respective lines drive the EL elements E11 to Enm to emit light.

The cathode line scan circuit 3 is provided with scan switches SY1 to SYm corresponding to the respective cathode scan lines B1 to Bm to work so that either one of a reverse bias voltage VM from a power supply circuit 5 (for example, 10 V) and the ground potential (0 V) is connected to a corresponding cathode scan line. The anode line drive circuit 2 is provided with drive sources I1 to In supplying drive current to the respective EL elements via the respective anode lines and drive switches SX1 to SXn, and the drive switches are controlled to be turned on so that current from the drive sources I1 to In is supplied to the respective EL elements arranged corresponding to the cathode scan lines.

In this embodiment, a variable voltage source 10 is disposed in the anode line drive circuit 2, and based on the voltage outputted from this variable voltage source 10, the current values from the respective drive sources I1 to In can be controlled. Thus, by connecting the drive sources I1 to In to desired anode drive lines while the cathode scan lines are scanned at a predetermined cycle, the respective light emitting elements are selectively caused to emit light. Constant current sources are employed for the drive sources I1 to In in this embodiment.

The respective anode drive lines are further connected to the reset circuit 4. This reset circuit 4 is provided with respective reset switches SR1 to SRn provided for the respective anode drive lines, and these reset switches are turned on so that the anode drive lines are set to the ground potential. Each of the anode line drive circuit 2, the variable voltage source 10 disposed in this anode line drive circuit 2, the cathode line scan circuit 3, and the reset circuit 4 is driven by command signals brought from a light emission control section 11 constituting a light emission control means. The lighting operation of the display panel 1 and the cathode reset operation are already explained with reference to FIG. 9 and FIG. 10.

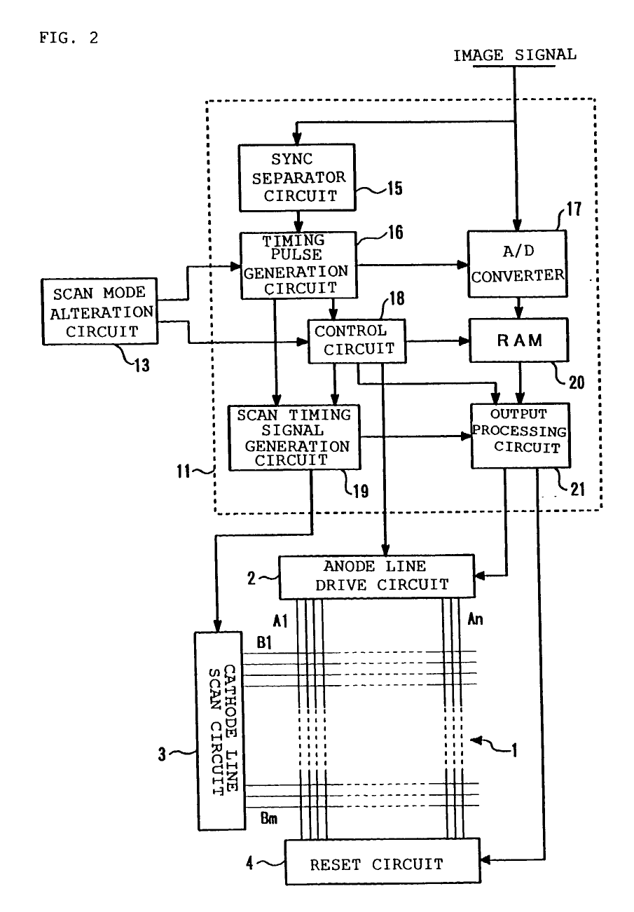

FIG. 2 shows a detailed structure of the light emission control section 11 shown in FIG. 1 as a block diagram. An image signal supplied from an image signal generation system which is not shown is sent to the light emission control section 11. The image signal is supplied to a sync separator circuit 15, and the sync separator circuit 15 extracts horizontal and vertical sync signals from the supplied input image signal and sends these sync signals to a timing pulse generation circuit 16. The timing pulse generation circuit 16 generates a sync signal timing pulse based on the extracted horizontal and vertical sync signals, and sends the timing pulse to each of an A/D (Analog-to-Digital) converter 17, a control circuit 18, and a scan timing signal generation circuit 19.

The A/D converter 17 converts the input image signal to digital pixel data corresponding to one pixel in synchronism with the timing pulse brought from the timing pulse generation circuit 16, and sends the pixel data to a memory 20 composed of a RAM. This memory 20 at least has a storage area of image data of one screen (one frame) of the luminescence display panel 11.

The control circuit 18 sends a write-signal and a read-signal synchronous with the timing pulse brought from the timing pulse generation circuit 16 to the memory 20. The memory 20 sequentially incorporates individual pieces of pixel data supplied from the A/D converter 17 in accordance with the write-signal. In accordance with the read-signal, the memory 20 sequentially reads the pixel data stored in the memory 20 and sends the data to an output processing circuit 21 of the next section.

The scan timing signal generation circuit 19 generates timing signals to control the scan switches SY1 to SYm in the cathode line scan circuit 3 based on the timing pulse brought from the timing pulse generation circuit 16. Thus, a scan selection control signal is supplied from the scan timing signal generation circuit 19 to the cathode line scan circuit 3. Further, the timing signal is supplied from the scan timing signal generation circuit 19 to the output processing circuit 21, and the output processing circuit 21 supplies a drive control signal in accordance with the pixel data supplied from the memory 20 to the anode line drive circuit 2 in synchronism with the timing signal. Thus, drive current based on the image data is selectively supplied to the anode line in synchronism with the cathode line scan, and an image based on the image signal is reproduced in the luminescence display panel 1.

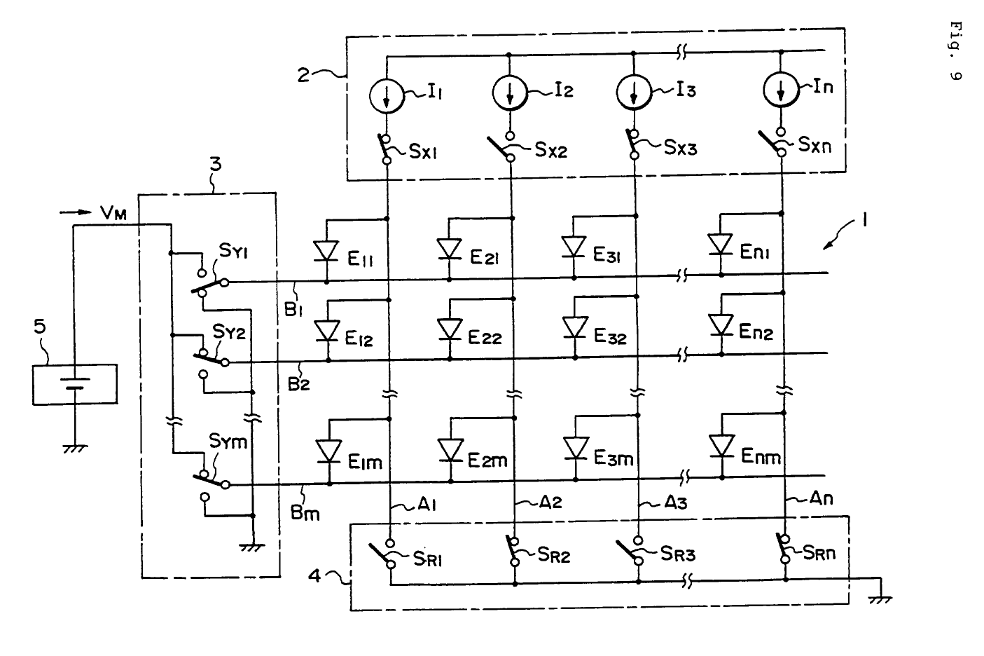

The control circuit 18 supplies a reset signal to the reset circuit 4 via the output processing circuit 21 during a reset period and supplies the same reset signal to the cathode line scan circuit 3 via the scan timing signal generation circuit 19. Thus, the cathode line reset operation explained with reference to FIG. 8 is performed.

In this embodiment, a control signal is supplied from an alteration circuit 13 constituting a scan mode alteration means to the light emission control section 11. This scan mode alteration circuit 13 functions so as to select a normal scan mode in which all effective light emitting elements in the luminescence display panel 1 are repeatedly scanned to control the luminescence and a partial scan mode (partial scan) in which part of the effective light emitting elements in the luminescence display panel 1 are repeatedly scanned to control the luminescence. Accordingly, for example, in some cases this scan mode alteration circuit 13 sends a switching command signal to the light emission control section 11 by a manual operation, and in other cases it sends the switching command signal to the light emission control section 11 automatically.

For example, in the case where the present invention is adopted in a portable telephone, switching can be performed automatically so that the partial scan mode is selected in a waiting state of the telephone and the normal scan mode is selected in a telephone talking state. In this case, the scan mode alteration circuit 13 constitutes part of a transmitting/receiving circuit of the telephone or is constituted so that a signal showing the telephone talking state or a non-talking state from the transmitting/receiving circuit is supplied to the circuit 13, while the circuit 13 sends the switching command signal to the light emission control section 11.

As shown in FIG. 2, the scan mode alteration circuit 13 is constituted so that the switching command signal is sent to the timing pulse generation circuit 16 and the control circuit 18 that constitute the light emission control section 11. Here, when the switching is performed, for example, from the normal scan mode to the partial scan mode, or, conversely, from the partial scan mode to the normal scan mode, the switching command signal is sent from the scan mode alteration circuit 13 to the timing pulse generation circuit 16, and based on this signal, the timing pulse generation circuit 16 changes the cycle of the timing pulse.

The control circuit 18 receiving the switching command signal sent from the scan mode alteration circuit 13 sends a control signal determining the area of the cathode line scan to the scan timing signal generation circuit 19. Further, the control circuit 18 operates so as to change the cycle of write and read operations for the memory 20 and sends a control signal for changing the output voltage of the variable voltage source 10 in the anode line drive circuit 2.

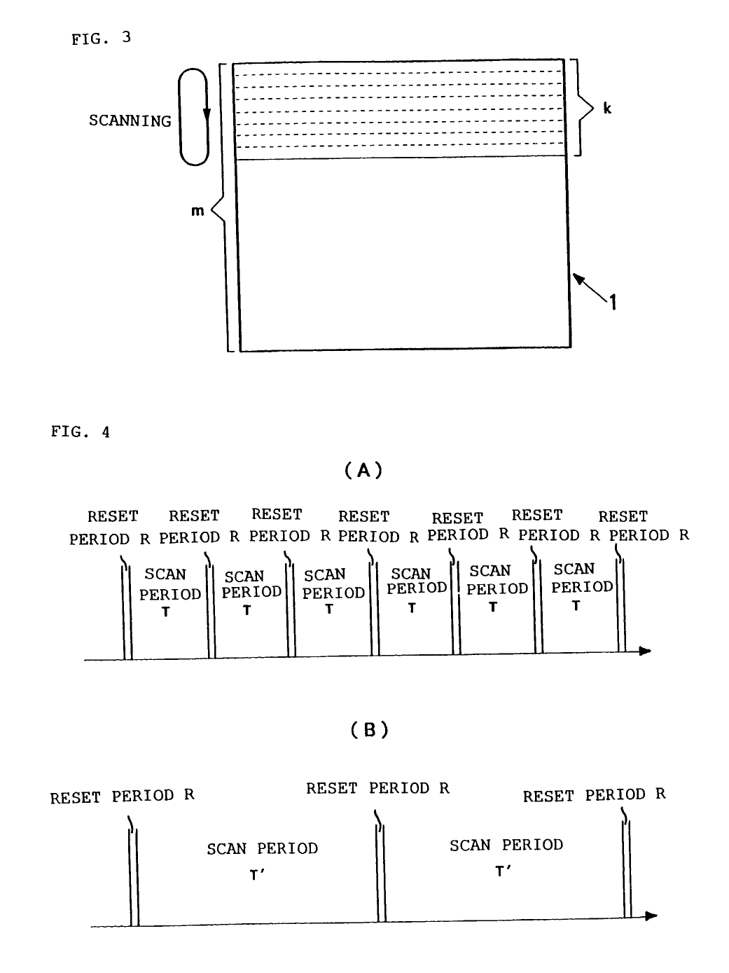

Here, in an example of the case where, for example, switching is performed from the normal scan mode to the partial scan mode, the display feature of the display panel and the concept of the scan period of this case are shown in FIG. 3 and FIG. 4. That is, in the partial scan mode, as shown in FIG. 3, for example, first to kth cathode lines in a total scan line “m” (the number of the cathodes lines) formed in the display panel 1 are scanned, proceeding to the next one frame scan without scanning the respective cathode lines of “k+1”th to “m”th. That is, in the partial scan mode, only the cathodes lines from first to “k”th are repeatedly scanned.

Therefore, a scan period T of each scan line is switched from a state of FIG. 4A showing the case of the normal scan mode to a scan period T′ shown in FIG. 4B as the partial scan mode, to perform a change of the scan period. Here, each reset period R is a very short time period, and thus T′/T approximately corresponds to the relationship of m/k. The state shown in FIG. 3 shows the partial scan mode in which about ⅓ of an upper part in the display panel 1 is repeatedly scanned, and thus in this case, a scan period T′ is set to about 3 times the normal scan mode's.

In the partial scan mode, for example, there is also a case where scanning starts from “k+1”th, and there is a case where a finishing line of the partial scan of this time completes one scan before “m”th cathode line. Further, for example, there is a case where scanning starts from “k+1”th and is performed until “m”th cathode line. In these cases also, the scan period is set using a ratio similar to the ratio described above.

In a passive matrix type EL display device as used in the present embodiment, since when the scan period becomes longer the lighting time of a display element becomes longer in response thereto, the luminance of the display screen substantially increases. Therefore, at the time of switching to the partial scan mode, it is desired that an operation of decreasing the drive current supplied to each EL element be executed. The configuration shown in FIG. 2, a control signal is sent from the control circuit 18 to the variable voltage source 10 in the anode line drive circuit 2, and constructed is a current variable means (luminance variable means) for reducing the output current from the respective drive sources 11 to In which operate as constant current sources. That is, since the current flowing the EL element is approximately proportional to the emission luminance as described above, by reducing the drive current, it becomes possible to obtain an emission luminance substantially equal to the emission luminance of the case of the normal scan mode.

In the control circuit 18, parameters of data of a scan area of the cathode lines, the scan period of that case, control data given to the variable voltage source 10, and the like are constructed in a table form corresponding to the normal scan mode and several partial scan modes which can be selected. Therefore, in the case where a switching command of a partial scan mode is received from the scan mode alteration circuit 13, by referring to the table corresponding thereto, the respective parameters can be instantly obtained. This is performed similarly in any of the case where the normal scan mode is switched to the partial scan mode as described above, the case where the partial scan mode is switched to the normal scan mode, and the case where a partial scan mode is switched to another partial scan mode.

According to the present embodiment, in the case where the partial scan mode is selected, specific cathode lines are repeatedly scanned, and corresponding thereto, since a scan period is set for being longer, the interval of the cathode reset operation also becomes longer, so that useless power consumption accompanied by the cathode reset operation can be reduced. By reducing the number of scans, the luminance can be ensured even when the momentary luminance of the EL element is reduced. Thus, as the number of scans becomes smaller, the current outputted from the drive sources I1 to In can be decreased, and as a result, a power saving can be achieved.

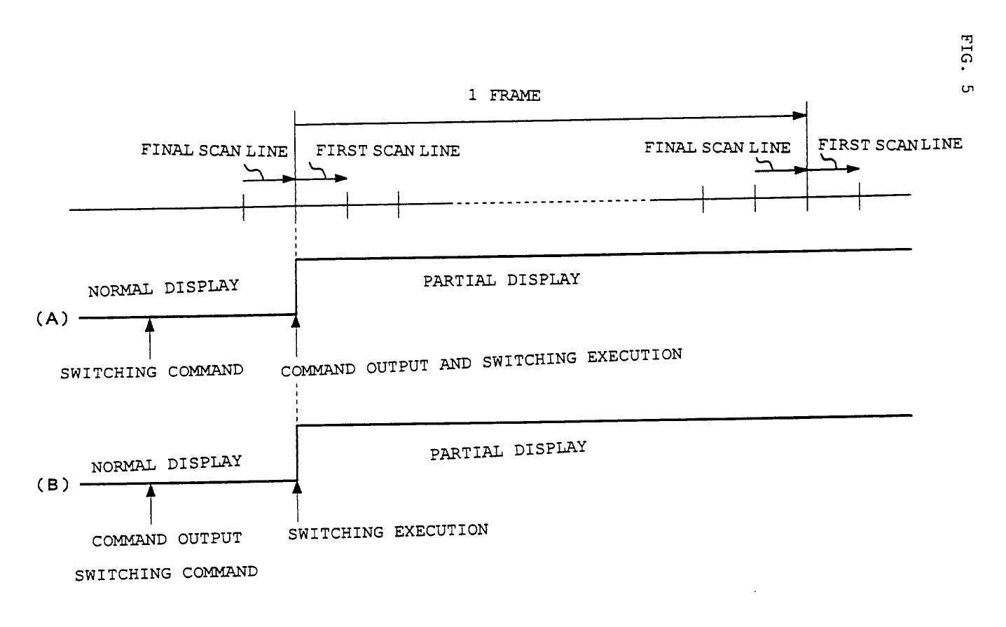

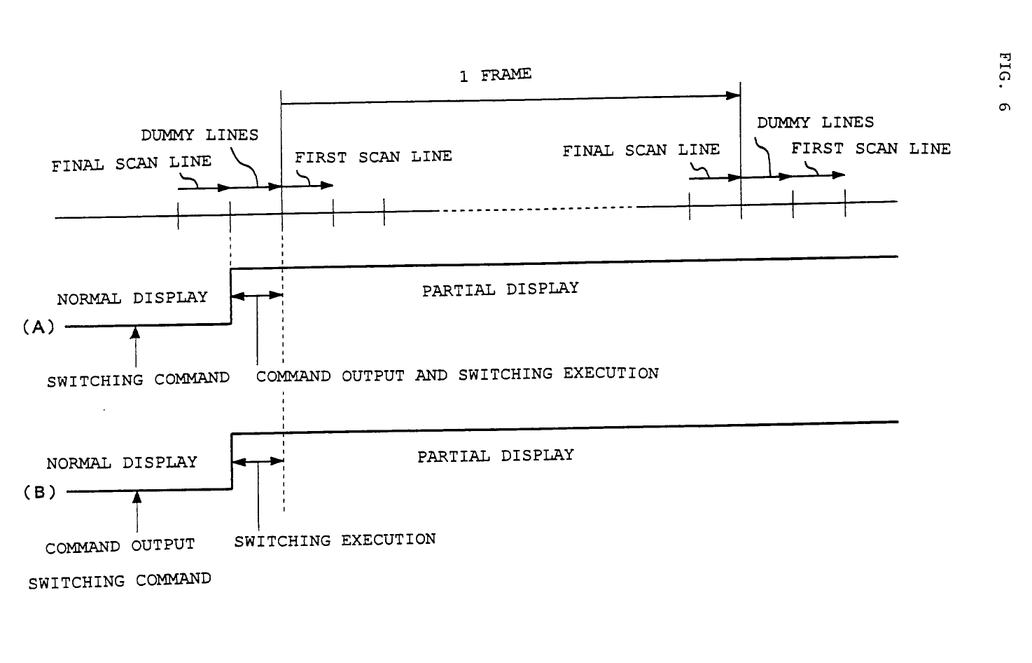

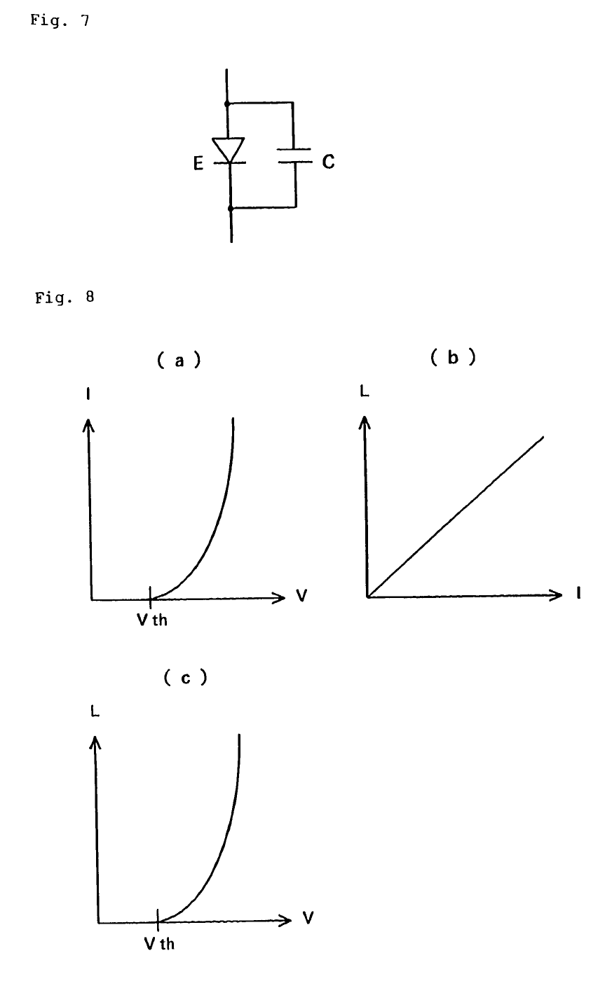

Here, preferred switching timing of the time a scan mode is switched in the configuration described above is explained with reference to timing charts shown in FIG. 5 and FIG. 6. As already described, it is found that when a scan mode is switched on the halfway of the scanning of one frame, a phenomenon such as unpleasant flicker and the like occurs in the present type of EL luminescence display device. In the present embodiment, a switching operation for each scan mode is executed in synchronism with the scanning start of the first scan line in each scan mode as shown in FIG. 5.

FIG. 5 shows an example of the case where the normal scan mode (indicated by NORMAL DISPLAY in FIG. 5) in which all effective light emitting elements in the display panel are repeatedly scanned to control the luminescence is switched to the partial scan mode (indicated by PARTIAL DISPLAY in FIG. 5) in which part of the effective light emitting elements in the display panel are repeatedly scanned to control the luminescence. In this case, with respect to the switching timing of a scan mode, the mode shown in FIG. 5A and the mode shown in FIG. 5B can be adopted.

The time to generate the switching command brought from the scan mode alteration circuit 13 to the light emission control section 11 shown in FIG. 2 is not necessarily synchronous with the first scan line constituting one frame, and in most cases, the switching command is generated on the halfway of the scanning of one frame in the normal scan mode as shown in FIG. 5. Therefore, regarding the switching timing shown in FIG. 5A, after the switching command is received from the scan mode alteration circuit 13, at the time of the scanning start of the first scan line whose light emission should be controlled in the partial display, the switching command is outputted, and the scanning by the partial display is executed in synchronism with the output of the switching command.

That is, in the switching control shown in FIG. 5A, when the switching command is received from the scan mode alteration circuit 13 shown in FIG. 2, the control circuit 18 operates so as to output the switching command at the time of arrival of the timing pulse indicating the start of the first scan line sent from the timing pulse generation circuit 16. Based on this switching command, the parameters of the data of a scan area of the cathode lines, the scan period of that case, control data given to the variable voltage source 10, and the like which are constructed in a table form in the control circuit 18 are read, and then switching is executed so that a partial display is immediately executed based on the parameters.

Regarding the switching timing shown in FIG. 5B, at the same time as the receipt of the switching command from the scan mode alteration circuit 13, in synchronism therewith, the switching command is outputted, and at the time of the scanning start of the first scan line whose light emission should be controlled in the partial display, scanning by the partial display is executed.

That is, in the switching control shown in FIG. 5B, when the switching command is received from the scan mode alteration circuit 13 shown in FIG. 2, the control circuit 18 immediately generates a command output. Then, the parameters of the data of a scan area of the cathode lines, the scan period of that case, control data given to the variable voltage source 10, and the like which are constructed in the table form in the control circuit 18 are read in synchronism with the arrival of the timing pulse sent from the timing pulse generation circuit 16 after the command output is generated, and the partial display is executed based on the parameters.

In either switching control shown in FIG. 5, since switching of a scan mode is executed in synchronism with the first scan line of one frame, occurrence of a phenomenon such as the unpleasant flicker and the like can be restrained.

Next, embodiments shown in FIG. 6 show cases where the switching operation of a scan mode is executed during the scanning of dummy lines set after a final scan line in each scan mode. The luminescence display panel is generally provided with cathode lines whose number is that required to correspond to the effective light emitting elements or greater. For example, even if a display standard is 64 lines, in reality, a surplus of several cathode lines are provided, and thus in the switching control shown in FIG. 6, a mode to scan the surplus of cathode lines (dummy lines) is set, so that during the scanning of the dummy lines the switching operation of a scan mode is executed.

In the switching operation shown in FIG. 6A, where the switching command from the scan mode alteration circuit 13 is received, at the time of scanning of the dummy lines, the control circuit 18 outputs the switching command. Based on this switching command, the parameters of the data of a scan area of the cathode lines, the scan period of that case, control data given to the variable voltage source 10, and the like which are constructed in the table form in the control circuit 18 are read, and control is performed so that a partial display is executed from the next first scan line based on the parameters.

In the switching operation shown in FIG. 6B, where the switching command from the scan mode alteration circuit 13 is received, the switching command is outputted in synchronism therewith, and at the time of the scanning of the dummy lines, a scan mode is set similarly to the setting described above, so that control is performed to execute a partial display from the next first scan line based on the respective parameters set.

In either switching control shown in FIG. 6, since the respective parameters corresponding to the next scan mode are set while the dummy lines are scanned so that scanning is started from the next first scan line according to a scan mode switched newly, occurrence of a phenomenon such as the unpleasant flicker and the like can be restrained.

Although any of embodiments in FIG. 5 and FIG. 6 is explained exemplifying the switching timing from the normal display to the partial display, also similarly performed are the switching operation from the partial display to the normal display and further the switching operation from a partial display to another partial display.

In the embodiment described above, for example, in the case where the normal scan mode is switched to the partial scan mode, in order to substantially restrain the enhancement of the luminance of the EL element due to extension of the scan period, a luminance variable means for reducing the output current from the respective drive sources I1 to In operating as constant current sources is adopted. However, this luminance variable means may be constituted so that drive time during the scanning period can be changed. In this case also, it is desired that respective data pieces of the data of a scan area of the cathode lines, the scan period of that case, and the drive time during the scan period be constructed in a table form in the control circuit 18, so that these are read and utilized.

As is apparent from the explanation described above, with a drive unit for a luminescence display panel according to the present invention, since a partial scan can be executed as the need arises, the power consumption can be reduced. Further, since the switching operation of a scan mode is performed at the time of the start of scanning of the first scan line or during the scanning of the dummy lines set after the final scan line, it can be effectively restrained that an unpleasant phenomenon such as flicker and the like occurs on the display panel, accompanied by the switching operation of a scan mode.

What is claimed is:

1. A drive unit for a luminescence display panel which includes a plurality of drive lines and a plurality of scan lines intersecting each other and a plurality of capacitive light emitting elements connected between the drive lines and the scan lines at a plurality of intersecting positions by the scan lines and the drive lines,
The drive unit comprising a light emission control means which can select a normal scan mode in which all effective light emitting elements in the luminescence display panel are repeatedly scanned to control the luminescence thereof and a partial scan mode in which part of the effective light emitting elements in the luminescence display panel are repeatedly scanned to control the luminescence thereof, wherein the light emission control means executes a switching operation for the respective scan modes in synchronism with scanning start of a first scan line in each scan mode.

2. A drive unit for a luminescence display panel which includes a plurality of drive lines and a plurality of scan lines intersecting each other and a plurality of capacitive light emitting elements connected between the drive lines and the scan lines at a plurality of intersecting positions by the scan lines and the drive lines,
The drive unit comprising a light emission control means which can select a normal scan mode in which all effective light emitting elements in the luminescence display panel are repeatedly scanned to control the luminescence thereof and a partial scan mode in which part of the effective light emitting elements in the luminescence display panel are repeatedly scanned to control the luminescence thereof, wherein the light emission control means executes a switching operation for the respective scan modes during scanning of a dummy line set after a final scan line in each scan mode.

3. The drive unit for the luminescence display panel as claimed in claim 1 or 2, wherein the light emission control means is constituted to perform a switching operation from the normal scan mode to the partial scan mode and a switching operation from the partial scan mode to the normal scan mode.

4. The drive unit for the luminescence display panel as claimed in claim 1 or 2, wherein the light emission control means is constituted to perform a switching operation from the partial scan mode to another partial scan mode.

5. The drive unit for the luminescence display panel as claimed in claim 1, wherein the light emission control means is constituted to output a switching command at the time of the scanning start of a first scan line whose light emission should be controlled in the next after receiving a switching command from a scan mode alteration means, so that a scan mode can be switched in synchronism with the output of the switching command.

6. The drive unit for the luminescence display panel as claimed in claim 1, wherein the light emission control means is constituted so as to outputs a switching command in synchronism with a switching command from a scan mode alteration means and is constituted so that a scan mode can be switched at the time of the scanning start of a first scan line whose light emission should be controlled in the next.

7. The drive unit for the luminescence display panel as claimed in claim 2, wherein the light emission control means is constituted to output a switching command at the time of the scanning of the dummy line after receiving a switching command from a scan mode alteration means, so that a scan mode can be switched in synchronism with the switching command.

8. The drive unit for the luminescence display panel as claimed in claim 2, wherein the light emission control means is constituted to output a switching command in synchronism with a switching command from a scan mode alteration means and is constituted so that a scan mode can be switched at the time of the scanning of the dummy line.

9. The drive unit for the luminescence display panel as claimed in claim 1 or 2, wherein the light emission control means is provided with a scan period alteration means for changing the scan period of a scan line in accordance with the number of scan lines in each scan mode.

10. The drive unit for the luminescence display panel as claimed in claim 1 or 2, wherein the light emission control means is provided with a luminance variable means for controlling emission luminance in accordance with the number of scan lines in each scan mode.

11. The drive unit for the luminescence display panel as claimed in claim 1 or 2, wherein the light emission control means is provided with a reset control means for setting a reset period for each end of the scan period of a first scan line, the reset control means executing an operation for making the electrical potentials of all of the plurality of drive lines and the plurality of scan lines the same during the reset period.

12. The drive unit for the luminescence display panel as claimed in claim 1 or 2, wherein the light emitting elements are organic electroluminescence elements.
